(19) United States
(12) Patent Application Publication
(10) Pub. No.: US 2015/0351339 A1
(43) Pub. Date: Dec. 10, 2015

(54) HYDROPONIC CONTAINER AND SYSTEM

(71) Applicant: Matthew Shane Carmody, Blissfield, MI (US)

(72) Inventor: Matthew Shane Carmody, Blissfield, MI (US)

(21) Appl. No.: 14/735,328

(22) Filed: Jun. 10, 2015

Related U.S. Application Data
(60) Provisional application No. 62/010,207, filed on Jun. 10, 2014.

(51) Int. Cl. A01G 31/02; A01G 27/00

(52) U.S. Cl. CPC A01G 31/02; A01G 27/008; A01G 27/005; A01G 27/003

(57) ABSTRACT

A hydroponic fluid container is disclosed that includes a body having a bottom wall defining an aperture and an internal surface and at least one sidewall defining an internal surface, the internal surface of the at least one sidewall and the internal surface of the bottom wall defining a fluid-holding cavity, the internal surface of the bottom wall extending inwardly and downwardly, at a gentle slope, from a distal end of the internal surface of the at least one sidewall toward the aperture. The container also includes a drain in fluid communication with the aperture and a valve disposed therein. Additionally, the container has at least one support leg spacing an exit portion of the drain in an interposing relationship with a portion of the bottom wall and a distal end of the at least one support leg.

### CROSS-REFERENCE TO RELATED APPLICATION

This application claims priority to U.S. Provisional Patent Application No. 62/010,207, filed Jun. 10, 2014, the entirety of which is incorporated by reference.

### FIELD OF THE INVENTION

The present invention generally relates to a hydroponic container and system, and, more particularly, relates to a container with legs, a sloped surface, and a drain and valve coupled therefore for the convenient and efficient removal of waste fluid from the container.

### BACKGROUND OF THE INVENTION

The availability of agricultural land for the cultivation of crops has steadily decreased in an inverse relationship to population growth. Fortunately, the growth of hydroponics, a method of growing plants in nutrient-enriched fluid, instead of soil, is outpacing the estimate of global population growth by 80 percent according to a recent estimate from the International Monetary Fund. Although containers for hydroponics are well known in the art, they suffer from a number of disadvantages.

The fluid in a hydroponic container must be periodically changed or circulated and must provide for the removal of sediment. Prior hydroponic containers lack drainage means or drain inefficiently. Other containers lack a valve that controls whether fluid is allowed or prevented from draining. Prior containers also lack aeration systems to ensure the fluid in the container has sufficient circulation for optimal growing conditions. Finally, although there are systems in the current art for joining hydroponic containers into a network, such containers often do not provide optimal clearance for the area surrounding the containers so that the user can monitor conditions in the containers and remove and insert plants therein.

Therefore, a need exists to overcome the problems with the prior art as discussed above.

### SUMMARY OF THE INVENTION

The invention provides a hydroponic container and system that overcomes the hereinafore-mentioned disadvantages of the heretofore-known devices and methods of this general type and that provides an efficient and cost-effective hydroponic container for growing plant material in non-soil mediums.

With the foregoing and other objects in view, there is provided, in accordance with the invention, a hydroponic fluid container that includes a body having a bottom wall defining an aperture and an internal surface, at least one sidewall with a top peripheral edge, a bottom peripheral edge, opposite the top peripheral edge, with the sidewall defining an internal surface, and with the sidewall extending upwardly from the bottom wall. The internal surface of the at least one sidewall and the internal surface of the bottom wall define a fluid-holding cavity. The internal surface of the bottom wall extends inwardly and downwardly, at a gentle slope, from a distal end of the internal surface of the at least one sidewall toward the aperture. The container also includes a drain coupled to the bottom wall and has a valve disposed therein and that is in fluid communication with the aperture. The container also has at least one support leg extending from the bottom wall for supporting the body of the container on a support surface, with the at least one support leg spacing an exit portion of the drain in an interposing relationship with a portion of the bottom wall and a distal end of the at least one support leg.

In accordance with a further feature of the present invention, the entire internal surface of the bottom wall extends inwardly and downwardly, at the gentle slope, from the distal end of the internal surface of the at least one sidewall toward the aperture. Further, the aperture defined by the bottom wall may be concentrically disposed on the internal surface of the bottom wall.

In accordance with yet another feature of the present invention, the internal surface of the bottom wall is angled at most 15 degrees from an imaginary plane defined by the bottom peripheral edge of the at least one sidewall and the imaginary plane is formed at a substantially perpendicular angle to the from the distal end of the internal surface of the at least one sidewall.

In accordance with another feature, an embodiment of the present invention includes an aeration assembly coupled to the body of the container and at least partially disposed within the cavity of the container, with the aeration assembly including a diffuser with at least one diffuser aperture defined by a surface thereof and an arm having a proximal end opposite a distal end, the proximal end coupled to the diffuser and the distal end protruding outwardly beyond the bottom wall, and with the distal end couplable to a gas source.

In accordance with another feature, an embodiment of the present invention includes an aeration assembly coupled to the body of the container and at least partially disposed within the cavity of the container. The aeration assembly also includes a diffuser with at least one diffuser aperture defined by a surface thereof, with the at least one diffuser aperture in fluid communication with the cavity and the assembly also includes an arm having a proximal end opposite a distal end, the proximal end coupled to the diffuser and the distal end couplable to a gas source and defines an airway passage from the distal end to the at least one diffuser aperture for allowing air to flow from the gas source into the cavity through the at least one diffuser aperture.

In accordance with an additional feature, an embodiment of the present invention includes at least one plant support operably configured to support at least a portion of a plant material thereon and that is couplable to the internal surface of the at least one sidewall. In additional embodiments, the at least one plant support will be operably configured to support at least a portion of a plant material thereon and have a support structure couplable to the internal surface of the at least one sidewall, with the support structure removably couplable to a plurality of retention devices vertically spaced apart along the internal surface of the at least one sidewall for selectively adjusting a height of the at least one plant support from the internal surface of the bottom wall.

In accordance with a further feature of the present invention, the entire bottom wall extends inwardly and downwardly, at a gentle slope, from the bottom peripheral edge of the at least one sidewall toward the aperture.

In accordance with an additional feature of the present invention, the body includes at least one support leg extending from the bottom wall to support the container on a support surface thereunder and the at least one support leg separates the bottom wall from the support surface a distance of between approximately 2 to 8 inches.

In accordance with an additional feature, an embodiment of the present invention includes a removably copuplable insert sized to frictionally engage a substantial portion of the internal surface of the at least one sidewall.

A hydroponic fluid container system is also disclosed that includes (1) a plurality of hydroponic fluid containers supported on a ground surface, each hydroponic fluid container including a body and has a bottom wall defining an aperture and at least one sidewall extending upwardly from the bottom wall, the at least one sidewall and the bottom wall defining a fluid-holding cavity. The fluid container also has a drain coupled to the bottom wall and has an exit portion in an interposing relationship with a portion of the bottom wall and the ground surface and is in fluid communication with the aperture, with the bottom wall extending inwardly and downwardly from a bottom peripheral edge of the at least one sidewall toward the aperture at a gentle slope. The container also has an open portion defined by a bottom peripheral edge of the at least one sidewall and the ground surface, the open portion sized to provide access to the exit portion of the drain. The system also includes (2) a reservoir and (3) a fluid passageway assembly extending from the reservoir to the drain of each of the plurality of hydroponic fluid containers.

In accordance with an additional feature, an embodiment of the present invention includes each of the plurality of hydroponic fluid containers having a fluid-control valve coupled to the drain and operably configured to selectively release a fluid within the cavity through the drain for transport to the reservoir.

In accordance with a further feature of the present invention, the reservoir is coupled to a pump operably configured to transport waste fluid from the cavity into the reservoir and is operably configured as a waste fluid receptacle.

In accordance with yet another feature of the present invention, the bottom wall is at most 15 degrees from an imaginary plane defined by the bottom peripheral edge of the at least one sidewall.

A hydroponic fluid container system is also disclosed that includes a body having a bottom wall defining an aperture and an internal surface, the inner surface of the bottom wall at least partially defining a fluid-holding cavity and a continuous sidewall with an inner surface at least partially defining the fluid-holding cavity, the continuous sidewall enclosing the fluid-holding cavity, and the sidewall extending upwardly from the internal surface of the bottom wall, with the internal surface of the bottom wall radially extending inwardly and downwardly, at a gentle slope, from a distal end of the internal surface of the continuous sidewall to the aperture. The system also has a drain coupled to the bottom wall and in fluid communication with the aperture and includes drain having a valve disposed therein. The system also includes at least one support leg extending in a direction downwardly away from the bottom wall, with the at least one support leg spacing an outer surface of the bottom wall from a distal end of the at least one support leg, wherein an exit of the drain is disposed beneath the outer surface of the bottom wall.

In an additional embodiment of the present invention, the gentle slope is of a line function with a slope of approximately negative 0.12 with respect from a left distal side of the body that symmetrically and radially extends about the aperture, the line function including a y-intercept of a value of zero corresponding to the distal end of the internal surface of the continuous sidewall.

Although the invention is illustrated and described herein as embodied in a hydroponic container and system, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the hydroponic container body. The terms “program,” “software application,” and the like as used herein, are defined as a sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is an elevational side view of a hydroponic fluid container in accordance with an embodiment of the present invention;

FIG. 2 is a cross-sectional view of the hydroponic fluid container of FIG. 1;

FIGS. 3a and 3b are close-up, fragmentary, cross-sectional views of the container of FIG. 1;

FIG. 4 is upwardly looking perspective view of the hydroponic fluid container of FIG. 1;

FIG. 5 is a bottom plan view of the hydroponic fluid container of FIG. 1;

FIG. 6 is a top, fragmentary, isometric view of the hydroponic fluid container of FIG. 1;

FIG. 7 is a cross-sectional view of a hydroponic fluid container with an insert in accordance with another embodiment of the present invention; and

FIG. 8 is a schematic view of a hydroponic fluid container system in accordance with yet another embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient hydroponic fluid container and assembly. Embodiments of the invention provide a container body defining a fluid holding cavity, the container body including a bottom wall declining at a gentle slope toward an aperture defined by the bottom wall. The aperture is connected to a drain operable to transport waste fluid within the cavity to a waste fluid receptacle for convenient and efficient waste removal. The gentle incline maximizes a clearance distance between the bottom wall and a ground surface for convenient access to the drain and water-control valves connected thereto. In addition, embodiments of the invention provide an aeration assembly for delivering oxygen rich air to the fluid-filled cavity, providing additional nutrients and circulating the nutrients throughout the fluid holding cavity. In another embodiment, the hydroponic fluid container includes a removeable insert sized and shaped to form a fluid-impermeable or water-tight seal against an inner surface of the cavity for convenient and efficient cleaning purposes. In yet another embodiment, a plurality of hydroponic fluid containers form a hydroponic system connected by a plurality of plumbing lines operable as a fluid passageway assembly for convenient and efficient removal of waste fluid from the container cavities. In one embodiment, the hydroponic system can further include a fluid waste receptacle coupled to a pump to draw in waste fluid from the containers and transport the waste to the fluid waste receptacle.

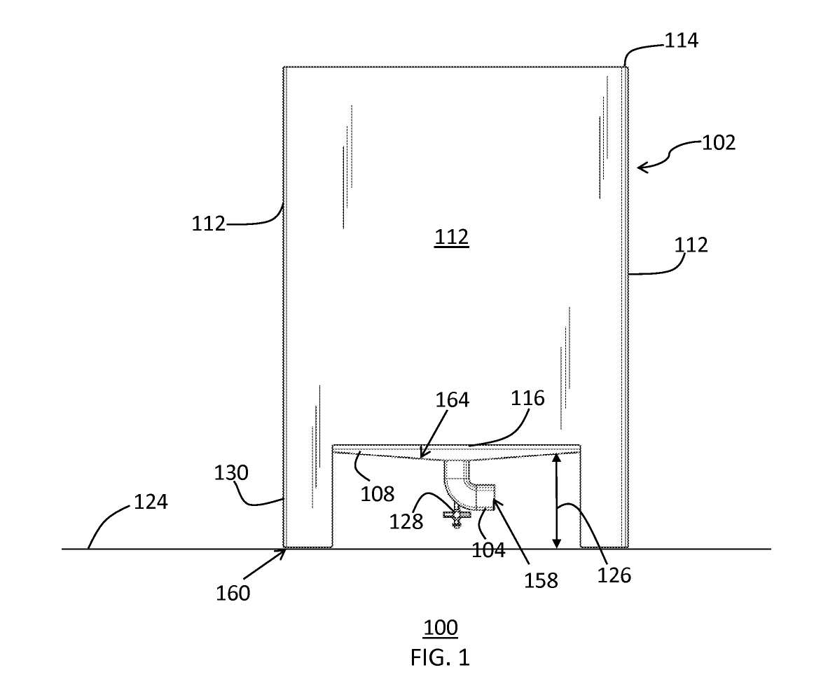

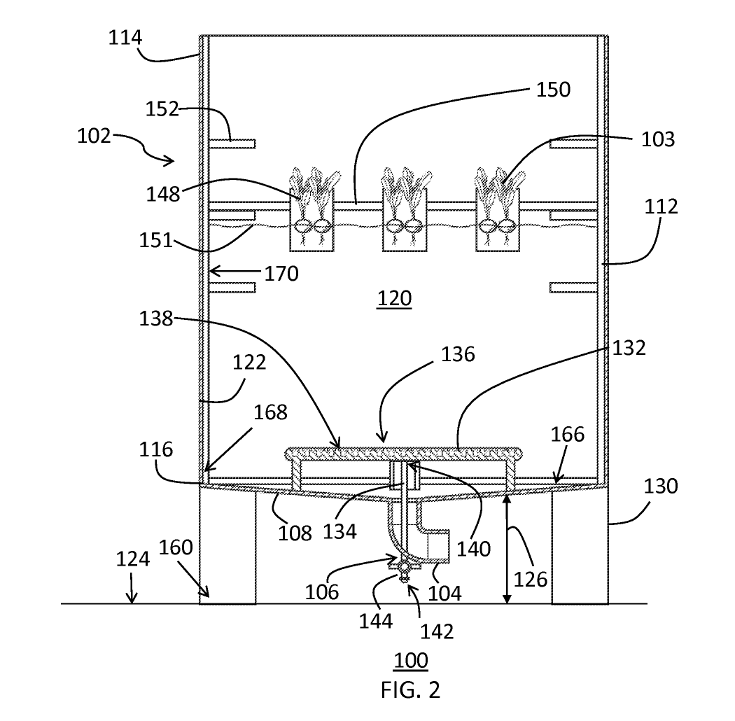

Referring now to FIGS. 1 and 2, one embodiment of the present invention is shown in an elevational front view and a cross-sectional view, respectively. FIGS. 1 and 2 show several advantageous features of the present invention, but, as will be described below, the invention can be provided in several shapes, sizes, combinations of features and components, and varying numbers and functions of the components. The first example of a hydroponic fluid container 100, as shown in FIGS. 1 and 2, includes a body 102, with a drain 104 coupled to a bottom portion of the body 102, and an aeration assembly 106 at least partially disposed within the container body 102. Advantageously, an exit portion 158 of the drain 104, i.e., a portion of the drain 104 exiting the physical structure of the body 102, can be seen positioned in an interposing relationship with a portion of the bottom wall 108 and a distal end 160 of at least one support leg 130. Said another way, the at least one support leg 130 provides the necessary vertical spacing or clearance, represented by an arrow 126, beneath the bottom wall 108 and the ground surface 124. In one embodiment, the spacing 126 is approximately 2-4 inches. In other embodiments, the minimum spacing is approximately 1 inch and the maximum spacing (to ensure vertical spatial efficiency) is approximately 12 inches. In another embodiment, the exit 158 of the drain 104 is disposed beneath an outer surface 164 of the bottom wall 108. In one embodiment, the overall height of the body 102 is approximately 18-24 inches. In other embodiments, the total height is greater than 6 inches and the total height is less than 60 inches.

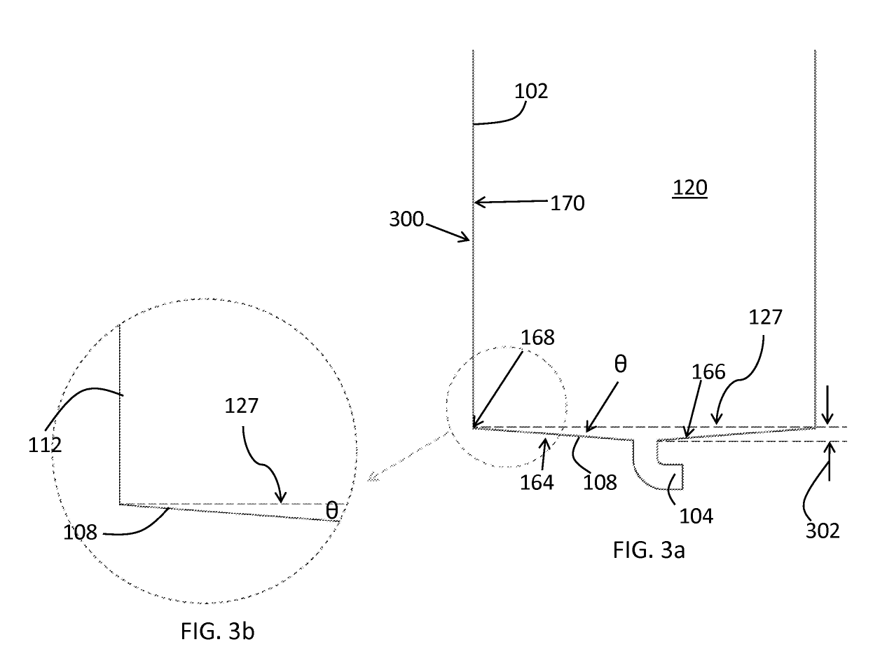

With reference to FIGS. 2 and 3a, the body 102 includes a bottom wall 108 defining an aperture 110. In one embodiment, the aperture 110 is centrally disposed relative to an outer perimeter of the body 102. The aperture 110 can be seen as concentrically disposed on an internal surface 166 of the bottom wall 108 to provide for a symmetrical and effective draining location for the fluid contained within a volume of the container 100. In another embodiment, the aperture 110 can be disposed in another location relative to the body 102. The aperture 110 is preferably disposed at a location that will not result in the formation of pockets of accumulated fluid within the container 100. Said another way, the internal surface 166 of the bottom wall 108 is preferably shaped and the aperture 110 positioned to allow for all the fluid stored in the container 100 to be removed with minimal fluid residue left behind. In some embodiments, the internal surface 166 of the bottom wall 108 may also have a dry-film anti-friction coating applied thereto, e.g., Dow Corning (MoS₂), to facilitate smooth and effective transportation of fluid in the container 100 into the drain 104. In one embodiment, the bottom wall 108 can be seen as tapering inwardly toward the aperture 110, allowing fluid within the container 100 to be channeled through the aperture 110.

The body 102 also includes at least one sidewall 112. In the exemplary embodiment, the body 102 includes a plurality of sidewalls 112, more specifically, four sidewalls 112. In one embodiment, the plurality of sidewalls 112 are integrally formed, defining a singular, unitary sidewall 112. In another embodiment, the sidewalls 112 are connected to one another forming a fluid-impermeable or watertight seal. Said another way, the sidewall 112 is continuous. In one embodiment, the sidewall 112 can be rectilinear, having a rectangular cross-section. In other embodiments, the sidewall 112 can be cylindrical-shaped, having a circular cross-section. In yet other embodiments, the sidewall 112 can be formed to resemble other shapes. The sidewall 112 includes a top peripheral edge 114 and a bottom peripheral edge 116, opposite the top peripheral edge 114. The top peripheral edge 114 can be seen as defining a rim of the body 102. The bottom peripheral edge 116 can be seen as defining a bottom edge of the sidewall 112. The bottom peripheral edge 116 may be the absolute end of the sidewall 112 portion of the body 102, just before the body 102 transitions to one or more portions of the bottom wall 108. In one embodiment, the bottom peripheral edge 116 is not the absolute end of the body 102, but merely delimits where the sidewall 112 portion of the body 102 terminates and the bottom wall 108 portion of the body 102 begins.

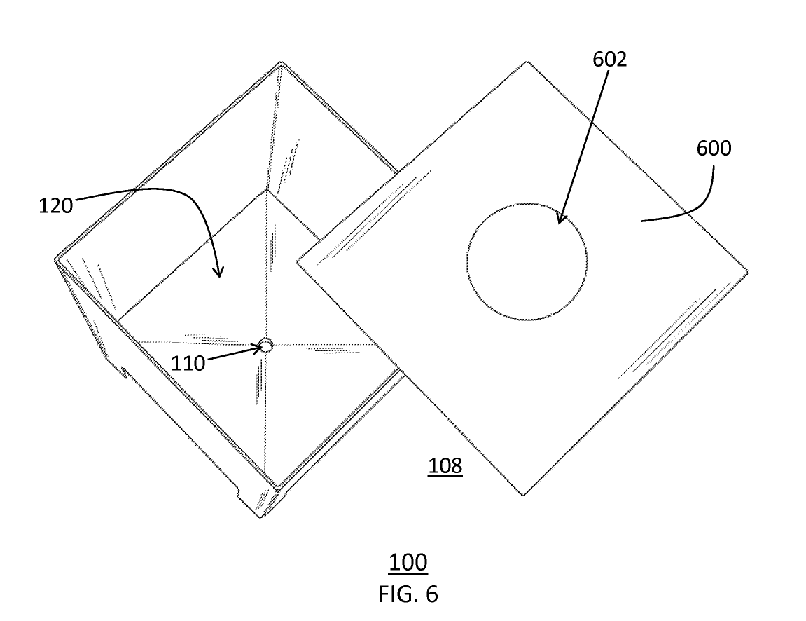

In one embodiment, the top peripheral edge 114 is formed to selectively engage a cover 600 (shown in FIG. 6) of the container 100. The cover 600 is operable to prevent unwanted debris from entering the container 100 and contaminating a plant material 103 therein. In one embodiment, the cover 600 includes a portion that allows light therethrough. The portion can be formed as an opening, e.g., opening 602, that allows natural or artificial light into the container 100. Alternatively, the portion can be a transparent substrate of the cover 600, such as glass or other transparent film that prevents unwanted debris from entering the container 100, while, at the same time, allowing beneficial light rays or solar radiation to enter the container 100. In one embodiment, the transparent substrate can be operably configured to block out light components that are within a spectrum considered harmful to plants.

In one embodiment, the sidewall 112 extends upwardly from the bottom wall 108. The bottom wall 108 may extend inwardly from a distal portion 168 of an internal surface 170 of the sidewall 112. The sidewall 112 and the bottom wall 108 together define a fluid holding cavity 120. More specifically, inner or internal surfaces 170, 166 of the sidewall 112 and the bottom wall 108, respectively, together define the fluid-holding cavity 120. The fluid-holding cavity 120 provides a volume where fluid can be stored, and, in some embodiments, conditioned. The volume can range from approximately 1-2 quarts to approximately 10-15 gallons, or even outside of these ranges, depending on the particular application. In some embodiments, the bottom wall 108 is joined with the sidewall 112 to be in a fluid-impermeable or watertight configuration.

In one embodiment, the internal surface 166 of the bottom wall 108 extends inwardly and downwardly from the distal portion 168 of the internal surface 170 of the sidewall 112 toward the aperture 110 at a gentle slope. In other embodiments, the entire bottom wall 108, i.e., internal and outer surfaces 166, 164, extend inwardly and downwardly from a portion of the sidewall 112. The term “downwardly” indicates a direction toward a ground surface 124, or other support structure on which the container 100 may rest. The term “inwardly” indicates a direction toward a center of the container 100, e.g., toward the aperture 110.

Referring now to FIGS. 2 and 3a-b, the gentle slope configuration is more particularly described. As used herein, the term “gentle slope” is intended to indicate a slope having a slight declination from a horizontal line, axis, or plane; such as a slope angle, θ, of at most 35 degrees from an imaginary plane 127 defined by the bottom peripheral edge 116 or distal end 168 of the sidewall 112. The gentle slope of the bottom wall 108 beneficially allows a gravitational force to channel fluid toward the aperture 110, while, at the same time, maximizing a clearance distance 126 between the bottom wall 108 and the ground surface 124. Maximizing the clearance distance 126 provides more convenient access to a fluid-control valve 128 that may be coupled to the drain 104. In direct contrast, steeply sloped bottom walls would obstruct the clearance 126, resulting in more difficult access to the drain 104 and the fluid-control valve 128 coupled thereto. In particular, steeply sloped bottom walls are not preferable for hydroponic containers configured to be supported by a support surface under the containers, such as the ground 124, because it would require the container body 102 to sit higher up from the support surface and, thereby, require more substantial support beneath the container body 102 to provide stability and ensure that the container body 102 would not be easily tipped over. Additionally, the slight declination of the gentle slope, and the location of the drain 104 beneath the bottom wall 108, prevents the accumulation of fluid on the bottom wall 108 or in the drain 104 that would result from a planar (i.e., no angular displacement) bottom wall configuration. In one embodiment, the bottom wall 108 is at an angle of between approximately 10 to approximately 15 degrees from the imaginary plane 127. In another embodiment, the bottom wall 108 is at angle of at most 15 degrees from the imaginary plane 127. In a preferred embodiment, the total longitudinal displacement, represented with the arrows 302, of the internal surface 166 from the distal end 168 is approximately 0.5 inch to maximize spatial efficiencies. In other embodiments, the total longitudinal displacement is approximately 0.3-2 inches. As the bottom wall 108 is preferably symmetrical with respect to the sidewall 112 from which it extends, the imaginary plane 127 is formed at a substantially perpendicular angle to the sidewall 112.

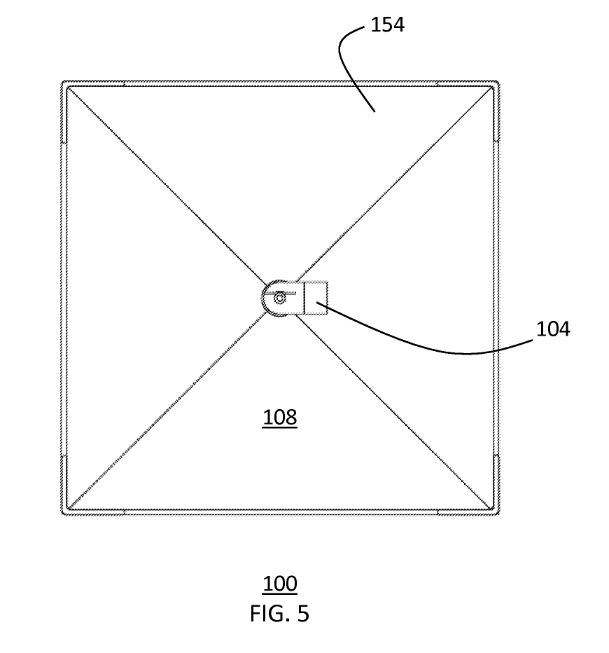

In another embodiment of the present invention, the gentle slope is of a line function with a slope of approximately negative 0.10 with respect from a left distal side 300 of the body 102. As seen in FIGS. 5 and 6, the slope symmetrically and radially extends about the aperture 110. The line function includes a y-intercept of a value of zero corresponding to the distal end 168 of the internal surface 170 of the sidewall 112. Said another way, if the sidewall 112 represented a “y-axis” and the imaginary plane/axis 127 represented the “x-axis” in slope/y-intercept form of a line function, the distal end 168 would be a value of zero and the internal surface 166 would decline downwardly at a slope of approximately negative 0.12 toward the aperture 110. In one embodiment, all other portions of the internal surface 166 may have a symmetrical shape. Said another way, if the body 102 was rotated or repositioned such that another portion of the container 100 was the left distal side 300, then that portion of the internal surface 166 extending from the distal end 168 would also be a slope of approximately negative 0.12. After testing, this slope has been found to advantageously facilitate in the most effective removal of fluid used to nourish a planting medium and to maximize the vertical spacing 126, while simultaneously reducing the overall height of the container 100.

Referring again primarily to FIGS. 1-2, the body 102 further includes at least one support leg 130 extending downwardly from the bottom wall 108 to support the container 100 on the ground surface 124, or other support surface thereunder. In one embodiment, there can be a pair of support legs 130. In another embodiment, there can be four support legs 130. In yet another embodiment, the support leg 130 separates the bottom wall 108 from the support surface 124, thereby creating a clearance distance 126 between approximately 2-6 inches. In further embodiments, the support leg 130 facilitates creating an open portion defined by the bottom peripheral edge 116 of the sidewall 112 and the ground surface 124. The open portion extends laterally, or is sized, from the bottom edge 116 to the exit portion 158 of the drain 104 to provide access to the same, similar to the clearance 126.

The primary purposes of the distance 126 separating the bottom wall 108 and the ground surface 124 is two-fold. First, it permits clearance for the drain 104 and second, it facilitates in providing a user access to the fluid-control valve 128 that may be utilized in connection with the drain 104. Advantageously, the gentle slope configuration of the bottom wall 108 also minimizes a height required by the support leg 130 and the overall height of the container 100.

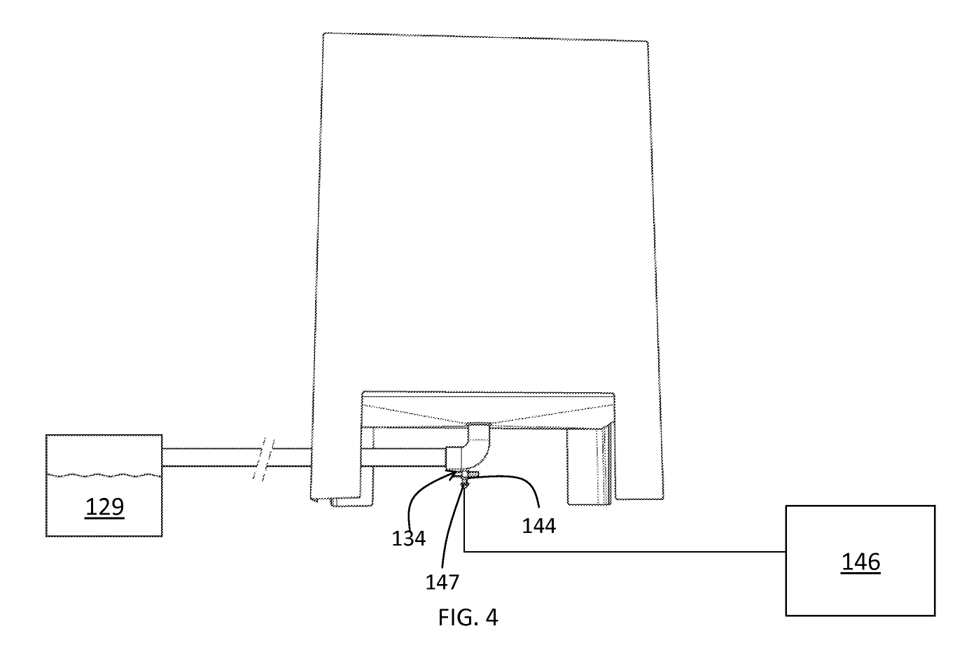

The drain 104 is coupled to the bottom wall 108 in a watertight configuration. In one embodiment, the body 102 and the drain 104 are mechanically connected to one another, forming a watertight seal. In another embodiment, the drain 104 and the body 102 are integral with one another, forming a watertight seal. Said another way, the body 102 and drain 104 may be formed as one piece or separate pieces. Because providing easy and efficient transportation of a container used in hydroponics is important to many users, the body 102 and drain 104 are preferably formed as a unitary piece and not detachable from one another. The drain 104 is in fluid communication with the aperture 110. As used herein, the term “drain” is defined as a channel or a pipe for transporting fluid. In one embodiment, the drain 104 is coupled to the fluid-control valve 128. The fluid-control valve 128 is operably configured to selectively release fluid, particularly fluid waste, within the cavity 120 through the drain 104 for transport to a reservoir 129, or fluid waste receptacle (see the schematic representation in FIG. 4) in fluid communication with the container 100. As is known in the art, hydroponic containers may be filled with a nutrient rich solution in which plant materials 103 are at least partially submerged; however, after a time period the solution accumulates waste particles from the plant and other materials, which results in a solution having waste particles. As used herein, the term “fluid waste” is intended to indicate a solution or other material having waste particles.

The aeration assembly 106 is coupled to the body 102 of the container 100 and at least partially disposed within the cavity 120 of the container 100. In one embodiment, the aeration assembly 106 is integrally formed with the body 102. In an alternative embodiment, the aeration assembly 106 is physically separable from the body 102, yet mechanically connected or otherwise coupled to the body 102. The aeration assembly 106 includes a diffuser 132 and an arm 134. In one embodiment, the diffuser 132 may have a top surface 136 defining at least one diffuser aperture 138, preferably, a plurality of diffuser apertures 138, in fluid communication with the cavity 120. In one embodiment, the diffuser apertures 138 are configured to be submerged within the fluid contained within the volume of the container 100. In another embodiment, the diffuser 132 is spaced above the internal surface 166 of the bottom wall 108 a sufficient distance for the fluid container 100 therein to run into the aperture 110. In one embodiment, the diffuser 132 is spaced above the internal surface 166 of the bottom wall 108 approximately 2-3 inches. The diffuser 132 is operable to disperse air or other gas traveling from the arm 134 into the container 100 to circulate nutrients throughout the fluid holding cavity 120 or to provide oxygenated fluid to the plant material 103.

The arm 134 may include a proximal end 140 opposite a distal end 142, the proximal end 140 coupled to the diffuser 132 and the distal end 142 protruding outwardly beyond the bottom wall 108. In one embodiment, the arm 134 protrudes outwardly from the bottom wall 108. In another embodiment, the bottom wall 108 defines an opening through which the arm 134 extends downwardly, toward the ground surface 124. In one embodiment, the opening can be the aperture 110. In an alternative embodiment, the opening can be separate from the aperture 110, yet still forming a fluid-impermeable seal with the arm 134 to prevent leakage.

Referring now primarily to FIGS. 2 and 4, the distal end 142 of the arm 134 preferably has a male hose coupling 144, but the arm 134 may use other fastening ends known by those of skill in the art to facilitate in the transfer of air or gas to the diffuser 132 from a gas source 146. In one embodiment, the distal end 142 of the arm 134 is fluidly coupled to the gas source 146 in an airtight configuration. The arm 134 defines an airway passage 147 from the distal end 142 to the diffuser apertures 138 for allowing air to flow from the gas source 146 into the cavity 120 through the diffuser apertures 138. Stated another way, the arm 134 can be said to define an airtight channel that extends from the end with the male hose coupling 144 to the diffuser apertures 138 defined by the diffuser 132 to permit air or gas to flow from the gas source 146 to the container 100. The gas source 146 can be, for example, an air tank or a compressor. In one embodiment, the arm 134 may have a valve coupled thereto and operably configured to, mechanically and/or electronically, control a flow of gas or air into the diffuser 132.

Referring again to FIG. 2, the hydroponic fluid container 100 further includes a plant support 148 operably configured to support at least a portion of the plant material thereon 103. The plant support 148 can be any structure operable to contain, or otherwise support the plant material 103 for receiving nourishment from a non-soil medium/substrate and growing within the container 100. The plant material 103 can include, for example, seeds, roots, sprouts, or the like. In one embodiment, the plant support 148 may include a bowl-shaped container defining a plurality of apertures sized to allow a nutrient rich fluid to pass therethrough, yet small enough that the plant material 103 will remain within a cavity of the bowl-shaped container and not fall through the plurality of apertures. In one embodiment, the plant supports 148 are positioned along a length of the sidewall 112 such that a fluid level 151 of a nutrient-rich fluid/solution within the cavity 120 is sufficient to submerge at least a portion of the plant material 103 within the nutrient-rich fluid/solution for receiving said nutrients from the fluid/solution.

In one embodiment, the plant support 148 is couplable to the sidewall 112. Preferably, the plant support 148 is selectively couplable along the length of the sidewall 112 for optimum vertical placement within the container 100. For example, when the plant material 103 is a seedling, the fluid level 151 can be relatively low, closer to the bottom wall 108. However, as the plant material 103 grows outwardly, roots may extend vertically such that the plant material 103 should optimally be moved upward, farther from the bottom wall 108, to allow the roots to continue to grow vertically, unobstructed. In one embodiment, the plant support 148 has a support structure 150 couplable to the sidewall 112. The support structure 150 can be, for example, a shelf-like structure mechanically couplable to the sidewall 112, the shelf-like structure providing a surface on which the plant supports 148 can rest thereon, or therein. In another embodiment, the support structure 150 is removably, selectively couplable to a plurality of retention devices 152. The plurality of retention devices 152 can be vertically spaced apart along a height of the internal surface 170 of the sidewall 112 for selectively adjusting a height of the at least one plant support 148 from the bottom wall 108. In one embodiment, the retention device 152 can be a pair of ledges extending substantially horizontally from opposing sides of the sidewall 112, wherein the pair of ledges are operable to support the support structure 150 thereon. In other embodiments, the retention devices 152 can be male or female fasteners configured to engage and fasten to a mating fastener end of the support structure 150.

FIG. 5 presents a bottom plan view of the container 100, illustrating an embodiment of the bottom wall 108 and the drain 104. As can be seen, in one embodiment, the bottom wall 108 may include four triangular panels 154. The triangular panels 154 are mechanically coupled to one another in a watertight configuration, each panel declining toward a centrally disposed aperture 110 at an angle that can be said to be a gentle slope, as defined herein. The gentle slope of the bottom wall 108 advantageously provides sufficient clearance distance 126 between the bottom wall 108 and the ground surface 124 (see FIG. 1) to provide convenient access to the drain 104 for selective release of fluid waste therethrough via a valve 128. FIG. 6 illustrates the fluid-containing cavity 120 of the container 100 with an exemplary cover 600 partially removed, illustrating the gentle slope of the bottom wall 108 in a top fragmentary view.

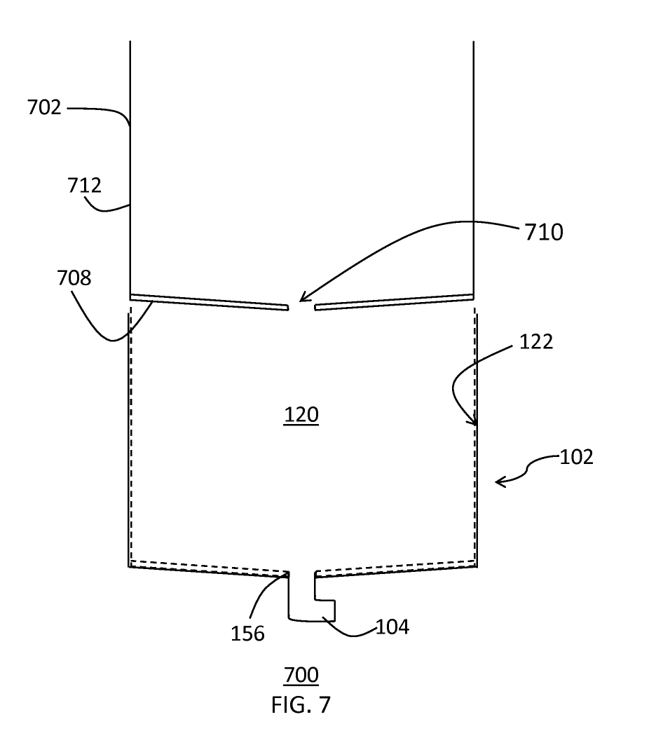

With reference to FIG. 7, a partial view of another embodiment of the present invention is shown in a cross-sectional view. The container 700 includes a removable insert 702 that also has side walls 712, a bottom wall 708, and an aperture 710, the aperture 710 defined by the bottom wall 708 and sized to receive a portion of the drain 104 and/or aperture 110 in a watertight configuration. The insert 702 advantageously provides the user with the ability to remove the insert 702 for easy cleaning, while simultaneously provide the draining capabilities described above. In one embodiment, the removable insert 702 is sized to frictionally engage a substantial portion of the inner surfaces 166, 170 of the body 102. In one embodiment, the insert 702 is sized to frictionally engage with only the inner surface 170 of the sidewall 122. In other embodiments, the insert 702 is sized to frictionally engage with only the bottom surface 166 of the wall 108, or a combination of the surfaces 166, 170. Stated another way, the insert 702 is shaped and sized to be slightly less in width (from one portion of the side wall(s) 712 to an opposing portion of the side wall(s) 712) than a width of the body 102 to assure a snug fit. In one embodiment, the insert 702 is made of a material that is rigid, or semi-rigid. In other embodiments, the insert 702 can be made of materials that are flexible and/or resilient. The bottom wall 708 is shaped and aligned with an upper edge 156 of the drain 104 to provide the advantageous draining capability. After the insert 702 is removed or installed, the user may then insert the aeration assembly 106, if applicable. The hash lines shown in FIG. 7 depict the insert 702 being moved into an installed, or second position, wherein a first position of the insert 702 is when the insert 702 is removed from the cavity 120 of the body 102 of the container 100. The insert 702 can be made of a polymer-based material from which fluid waste residue can be easily removed by cleaning. In another embodiment, the insert 702 can be configured to be a disposable material.

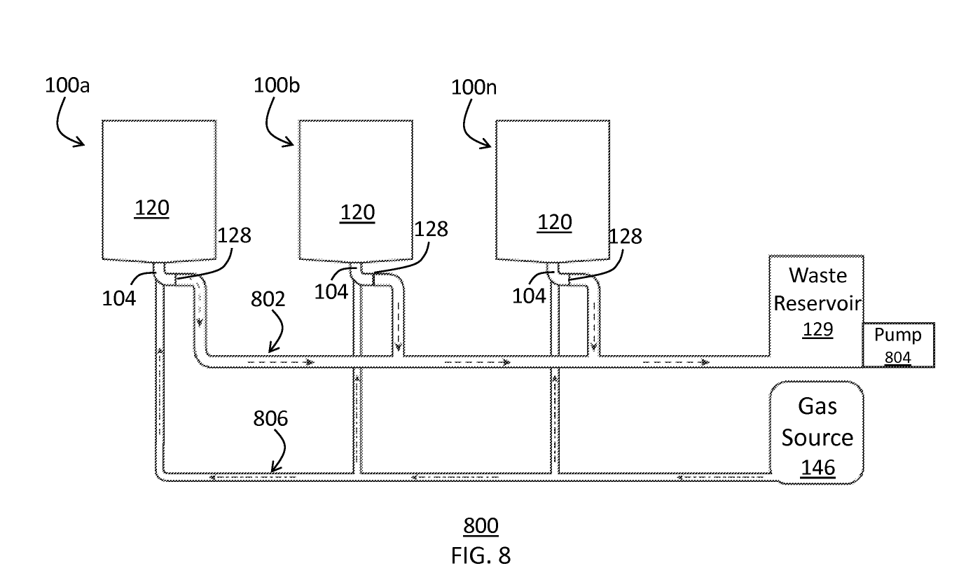

With reference to FIG. 8, an exemplary system 800 of hydroponic fluid containers coupled together via a fluid passageway assembly 802 is presented in a schematic view. In one embodiment, the system 800 includes a plurality of hydroponic fluid containers 100a-n fluidly coupled together via the fluid passageway assembly 802. The number of containers 100 from “a” to “n” can be any number. In one embodiment, the system 800 further includes the reservoir 129 and the fluid passageway assembly 802 extends from the reservoir 129 to the drain 104 of each of the plurality of containers 100a-n. In one embodiment, each of the plurality of containers 100a-n further includes a fluid-control valve 128 coupled to the drain 104; wherein, the fluid-control valve 128 operably configured to selectively release a fluid within the cavity 120 through the drain 104 for transport to the waste reservoir 129. Advantageously, the system 800 allows for individual container valves 128 to individually release waste fluid from each container 100. In one embodiment, the reservoir 129 is coupled to a pump 804 operably configured to transport waste fluid from the cavity 120 into the reservoir 129. The reservoir 129 may be considered “a waste fluid receptacle” because it is located downstream from the fluid accumulated in from the containers, i.e., waste fluid. In one embodiment, the plurality of containers 100a-n are horizontally disposed relative to one another. In other embodiments, the plurality of containers 100 are vertically disposed relative to one another. In yet other embodiments, the system 800 can include both horizontal and vertical configurations of the plurality of containers 100 respective to one another. The system 800 can further include the gas source 146 in fluid communication with each of the plurality of containers 100 via a second fluid passageway assembly 806 operable to transport air from the gas source 146 to the containers 100 via a corresponding aeration assembly arm 134 (not shown) of each of the plurality of containers 100a-n. The spacing or clearance 126, in addition to the slope of the surface 166, provided by the body 102 of the containers 100a-n facilitates in allowing users to manually, or electronically in some embodiments (through one or more microcontrollers communicatively coupled to a control via a network), to manipulate the valves 128, facilitate in the completely removal of fluid in the containers 100a-n, and reduce any exposed piping from the fluid passageway assembly 802.

A fluid container apparatus and system has been disclosed that includes a container body defining a cavity, the container body including a bottom wall declined at a gentle slope toward an aperture defined by the bottom wall. The aperture is connected to a drain in a fluid-impermeable configuration and is operably to transport waste within the cavity to a waste receptacle for convenient and efficient waste removal. The gentle incline advantageously maximizes a clearance distance between the bottom wall and a support surface for convenient access to the drain and associated valves. Embodiments of the present invention also provide an aeration assembly for circulating air within the cavity and a removable insert providing convenient and efficient cleaning of surfaces exposed to waste within the cavity.

What is claimed is:

1. A hydroponic fluid container comprising:
a body having:
a bottom wall defining an aperture and an internal surface; and
at least one sidewall:
including a top peripheral edge;
including a bottom peripheral edge, opposite the top peripheral edge;
defining an internal surface; and
extending upwardly from the bottom wall, the internal surface of the at least one sidewall and the internal surface of the bottom wall defining a fluid-holding cavity, the internal surface of the bottom wall extending inwardly and downwardly, at a gentle slope, from a distal end of the internal surface of the at least one sidewall toward the aperture;
a drain:
coupled to the bottom wall;
having a valve disposed therein; and
in fluid communication with the aperture; and
at least one support leg extending from the bottom wall for supporting the body of the container on a support surface, the at least one support leg spacing an exit portion of the drain in an interposing relationship with a portion of the bottom wall and a distal end of the at least one support leg.

2. The hydroponic fluid container in accordance with claim 1, wherein:
the entire internal surface of the bottom wall extends inwardly and downwardly, at the gentle slope, from the distal end of the internal surface of the at least one sidewall toward the aperture.

3. The hydroponic fluid container in accordance with claim 1, wherein
the aperture defined by the bottom wall is concentrically disposed on the internal surface of the bottom wall.

4. The hydroponic fluid container in accordance with claim 1, wherein:
the internal surface of the bottom wall is angled at most 15 degrees from an imaginary plane defined by the bottom peripheral edge of the at least one sidewall; and
the imaginary plane is formed at a substantially perpendicular angle from the distal end of the internal surface of the at least one sidewall.

5. The hydroponic fluid container in accordance with claim 1, further comprising:
an aeration assembly coupled to the body of the container and at least partially disposed within the cavity of the container, the aeration assembly including:
a diffuser with at least one diffuser aperture defined by a surface thereof; and
an arm having a proximal end opposite a distal end, the proximal end coupled to the diffuser and the distal end protruding outwardly beyond the bottom wall, the distal end couplable to a gas source.

6. The hydroponic fluid container in accordance with claim 1, further comprising:
an aeration assembly coupled to the body of the container and at least partially disposed within the cavity of the container, the aeration assembly including:
a diffuser with at least one diffuser aperture defined by a surface thereof, the at least one diffuser aperture in fluid communication with the cavity; and
an arm:
having a proximal end opposite a distal end, the proximal end coupled to the diffuser and the distal end couplable to a gas source; and
defining an airway passage from the distal end to the at least one diffuser aperture for allowing air to flow from the gas source into the cavity through the at least one diffuser aperture.

7. The hydroponic fluid container in accordance with claim 1, further comprising:
at least one plant support:
operably configured to support at least a portion of a plant material thereon; and
couplable to the internal surface of the at least one sidewall.

8. The hydroponic fluid container in accordance with claim 1, further comprising:
at least one plant support:
operably configured to support at least a portion of a plant material thereon; and
having by a support structure couplable to the internal surface of the at least one sidewall, the support structure removably couplable to a plurality of retention devices vertically spaced apart along the internal surface of the at least one sidewall for selectively adjusting a height of the at least one plant support from the internal surface of the bottom wall.

9. The hydroponic fluid container in accordance with claim 1, wherein:
the entire bottom wall extends inwardly and downwardly, at a gentle slope, from the bottom peripheral edge of the at least one sidewall toward the aperture.

10. The hydroponic fluid container in accordance with claim 1, wherein:
the body includes at least one support leg extending from the bottom wall to support the container on a support surface thereunder; and
the at least one support leg separates the bottom wall from the support surface a distance of between approximately 2 to 8 inches.

11. The hydroponic fluid container in accordance with claim 1, further comprising:
a removably copuplable insert sized to frictionally engage a substantial portion of the internal surface of the at least one sidewall.

12. A hydroponic fluid container system, the system comprising:
a plurality of hydroponic fluid containers supported on a ground surface, each hydroponic fluid container including:
a body:
having a bottom wall defining an aperture, and
having at least one sidewall extending upwardly from the bottom wall, the at least one sidewall and the bottom wall defining a fluid-holding cavity; and
a drain:
coupled to the bottom wall;
having an exit portion in an interposing relationship with a portion of the bottom wall and the ground surface; and
in fluid communication with the aperture;
the bottom wall extending inwardly and downwardly from a bottom peripheral edge of the at least one sidewall toward the aperture at a gentle slope; and
an open portion defined by a bottom peripheral edge of the at least one sidewall and the ground surface, the open portion sized to provide access to the exit portion of the drain;
a reservoir; and
a fluid passageway assembly extending from the reservoir to the drain of each of the plurality of hydroponic fluid containers.

13. The hydroponic fluid container system in accordance with claim 12, wherein each of the plurality of hydroponic fluid containers further comprises:
a fluid-control valve coupled to the drain and operably configured to selectively release a fluid within the cavity through the drain for transport to the reservoir.

14. The hydroponic fluid container system in accordance with claim 12, wherein:
the reservoir is:
coupled to a pump operably configured to transport waste fluid from the cavity into the reservoir; and
operably configured as a waste fluid receptacle.

15. The hydroponic fluid container system in accordance with claim 12, wherein:
the bottom wall is at most 15 degrees from an imaginary plane defined by the bottom peripheral edge of the at least one sidewall.

16. The hydroponic fluid container system in accordance with claim 12, further comprising:
an aeration assembly coupled to the body of the container and at least partially disposed within the cavity of the container.

17. The hydroponic fluid container system in accordance with claim 12, wherein the body of each of the plurality of hydroponic fluid containers further comprises:
at least one support leg extending from the bottom wall to support the container on the ground surface thereunder.

18. The hydroponic fluid container system in accordance with claim 12, wherein each of the plurality of hydroponic fluid containers further comprises:
a removable insert sized to frictionally engage a substantial portion of an inner surface of the cavity.

19. A hydroponic fluid container comprising:
a body having:
a bottom wall defining an aperture and an internal surface, the inner surface of the bottom wall at least partially defining a fluid-holding cavity; and
a continuous sidewall:
having an inner surface at least partially defining the fluid-holding cavity, the continuous sidewall enclosing the fluid-holding cavity; and
extending upwardly from the internal surface of the bottom wall, the internal surface of the bottom wall radially extending inwardly and downwardly, at a gentle slope, from a distal end of the internal surface of the continuous sidewall to the aperture;
a drain coupled to the bottom wall and in fluid communication with the aperture, the drain having a valve disposed therein; and
at least one support leg extending in a direction downwardly away from the bottom wall, the at least one support leg spacing an outer surface of the bottom wall from a distal end of the at least one support leg, wherein an exit of the drain is disposed beneath the outer surface of the bottom wall.

20. The hydroponic fluid container in accordance with claim 19, wherein:
the gentle slope is of a line function with a slope of approximately negative 0.12 with respect from a left distal side of the body that symmetrically and radially extends about the aperture, the line function including a y-intercept of a value of zero corresponding to the distal end of the internal surface of the continuous sidewall.
